(19) United States
(12) Patent Application Publication
(10) Pub. No.: US 2011/0001800 A1
(43) Pub. Date: Jan. 6, 2011

(54) Image capturing apparatus, image processing method and program

(75) Inventors: Kenichiro Nagao, Tokyo (JP); Atsushi Mae, Kanagawa (JP); Shunji Okada, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/802,433

(22) Filed: Jun. 7, 2010

(30) Foreign Application Priority Data
Jul. 3, 2009 (JP) P2009-158570

(51) Int. Cl. H04N 13/02; H04N 9/80; G06K 9/46

(52) U.S. Cl. 348/48; 348/47; 386/241; 382/190; 348/E13.074; 386/E09.011

(57) ABSTRACT

An image capturing apparatus includes a plurality of image capturing units that photograph images from a plurality of viewpoints, a recording controller that performs a process of recording a plurality of subject distances, which are measured by each of the plurality of image capturing units, on a recording unit as attribute information of the photographed images, and an image selection controller that performs a highlight scene extraction process by using subject distance information included in the attribute information. The image selection controller performs a process of determining whether a subject is located at a center area of an image frame by using the plurality of subject distances, which correspond to each of the plurality of image capturing units and are included in the attribute information, and selecting an image, for which the subject is determined to be located at the center area, as a highlight scene.

### BACKGROUND OF THE INVENTION

1. Field of the Invention

The invention relates to an image capturing apparatus, an image processing method and a program. More particularly, the invention relates to an image capturing apparatus that performs a process of selecting a highlight scene as a representative image from a photographed image, an image processing method and a program.

2. Description of the Related Art

In the case in which a plurality of moving images are photographed by and stored in an image capturing apparatus capable of photographing moving images, long time is necessary to reproduce the moving images. In such a case, a highlight scene extraction and display process is used to select a representative scene from the photographed image and display the representative scene. The highlight scene extraction and display process is, for example, disclosed in Japanese Unexamined Patent Application Publication No. 2007-134771.

Various schemes are used to extract a highlight scene. For example, there has been proposed a scheme of extracting a face detection frame from frames constituting a moving image (photographed image) and employing the face detection frame as a highlight scene by using a face recognition technology. In addition, there has been proposed a scheme and the like, which records zoom operation information (operation information of a camera at the time of photographing) and the like as attribute information of a photographed image, and extracts a frame image, which is allowed to correspond to attribute information indicating the generation of a user operation, as a highlight scene.

Separately from this, in recent years, as image capturing equipment, there has been developed an apparatus provided with a plurality of lenses and an image capturing device to photograph an image from different viewpoints in order to perform three-dimensional image display. For example, after an image (L image) for the left eye and an image (R image) for the right eye used for the three-dimensional image display are photographed by a plurality of lenses and an image capturing device provided in a camera, a display apparatus displays a three-dimensional image by using these images.

However, the above-described highlight scene extraction scheme may not be adapted for such a three-dimensional image. Since the highlight scene extraction scheme has been proposed in consideration of a two-dimensional image, it is possible to obtain a highlight scene adapted for a scene of a two-dimensional image. However, in the case in which the images are reproduced as a three-dimensional image, a case may occur in which the images are not adapted for a highlight scene.

For example, when a frame for which a face image has been recognized is selected as a highlight scene, the frame is extracted as the highlight scene even if a face is located at an end portion of the frame. However, it may be difficult for such an image to have a three-dimensional effect. Further, when a frame for which a zoom operation has been performed is selected as a highlight scene, it is probable that a scene in which a subject gradually recedes will be set as the highlight scene. In relation to such a scene, since the level of attention to the subject is reduced, it may not be preferred to extract the scene as the highlight scene.

### SUMMARY OF THE INVENTION

In view of the above issues, it is desirable to provide an image capturing apparatus capable of extracting a highlight scene serving as a representative image adapted for a three-dimensional image, an image processing method and a program.

According to one embodiment of the invention, there is provided an image capturing apparatus including a plurality of image capturing units that photograph images from a plurality of viewpoints, a recording controller that performs a process of recording a plurality of subject distances, which are measured by each of the plurality of image capturing units, on a recording unit as attribute information of the photographed images, and an image selection controller that performs a highlight scene extraction process by using subject distance information included in the attribute information, wherein the image selection controller performs a process of determining whether a subject is located at a center area of an image frame by using the plurality of subject distances, which correspond to each of the plurality of image capturing units and are included in the attribute information, and selecting an image, for which the subject is determined to be located at the center area, as a highlight scene.

In addition, according to one embodiment of the image capturing apparatus of the invention, the image selection controller performs a process of determining an existence of an image in which the subject approaches the image capturing apparatus according to passage of time with reference to the subject distances of the time-series photographed images, and selecting the image, for which the subject is determined to approach the image capturing apparatus, as the highlight scene.

In addition, according to one embodiment of the image capturing apparatus of the invention, the image selection controller performs a process of selecting a moving image, which is configured by consecutive photographed images including the image, for which the subject is determined to be located at the center area of the image frame, as the highlight scene.

In addition, according to one embodiment of the image capturing apparatus of the invention, the recording controller records the subject distance information in any one of a clip information file serving as a management file corresponding to a stream file set as a record file of a photographed moving image, and a play list file storing a reproduction list.

In addition, according to one embodiment of the image capturing apparatus of the invention, when the subject distance information is recorded in the clip information file, the recording controller records offset time from presentation time start time of a clip, which is prescribed in the clip information file, as time offset information representing a position of an image for which the subject distance is measured, and when the subject distance information is recorded in the play list file, the recording controller records offset time from in-time (InTime) set corresponding to a play item, which is included in a play list, as the time offset information representing the position of the image for which the subject distance is measured.

In addition, according to one embodiment of the image capturing apparatus of the invention, the recording controller performs a process of allowing face recognition information representing whether a face area is included in the images photographed by the image capturing units to be included in the attribute information, and recording the attribute information on a recording unit, and the image selection controller performs a process of selecting an image, for which face recognition has been performed, as the highlight scene with reference to the face recognition information included in the attribute information.

In addition, according to one embodiment of the image capturing apparatus of the invention, the recording controller performs a process of allowing GPS information representing a position, at which the images are photographed by the image capturing units, to be included in the attribute information, and recording the attribute information on a recording unit, and the image selection controller performs a process of selecting an image photographed at a specific position as the highlight scene with reference to the GPS information included in the attribute information.

In addition, according to one embodiment of the image capturing apparatus of the invention, the plurality of image capturing units are configured by at least three image capturing units, the recording controller performs a process of recording subject distances, which are measured by each of the at least three image capturing units, on a recording unit as attribute information of photographed images, and the image selection controller performs a process of determining whether a subject is located at a center area of an image frame by using the plurality of subject distances included in the attribution information and corresponding to each of the at least three image capturing units, and selecting an image, for which the subject is determined to be located at the center area, as the highlight scene.

According to another embodiment of the invention, there is provided an image processing method performed by an image capturing apparatus, the image processing method including the steps of photographing, by a plurality of image capturing units, images from a plurality of viewpoints, recording, by a recording controller, subject distances, which are measured by each of the plurality of image capturing units, on a recording unit as attribute information of the photographed images, and performing, by an image selection controller, a highlight scene extraction process by using subject distance information included in the attribute information, wherein in the step of performing the highlight scene extraction process, it is determined whether a subject is located at a center area of an image frame by using the plurality of subject distances included in the attribute information and corresponding to each of the plurality of image capturing units, and an image, for which the subject is determined to be located at the center area, is selected as a highlight scene.

According to further another embodiment of the invention, there is provided a program causing an image capturing apparatus to execute functions of allowing a plurality of image capturing units to photograph images from a plurality of viewpoints, allowing a recording controller to record subject distances, which are measured by each of the plurality of image capturing units, on a recording unit as attribute information of the photographed images, and allowing an image selection controller to perform a highlight scene extraction process by using subject distance information included in the attribute information, wherein in the highlight scene extraction process, it is determined whether a subject is located at a center area of an image frame by using the plurality of subject distances included in the attribute information and corresponding to each of the plurality of image capturing units, and an image, for which the subject is determined to be located at the center area, is selected as a highlight scene.

In addition, for example, the program according to the embodiment of the invention can be provided to an image processor and a computer system, which can execute various types of program codes, by a computer-readable recording medium or communication medium. Such a program is provided in the computer-readable format, so that processes according to the program can be performed in the image processor and the computer system.

Other objects, features and advantages of the invention will be apparent through an embodiment of the invention and detailed description based on the accompanying drawings. Further, a system in the specification corresponds to a logical aggregation of a plurality of apparatuses, and it is not necessarily that the apparatuses having each configuration exist in the same casing.

According to one embodiment of the invention, in the image capturing apparatus that records photographed images from a plurality of viewpoints, subject distance information measured by a plurality of image capturing unit corresponding to each viewpoint is recorded as the attribute information of the photographed image. Further, when performing the highlight scene selection process, after determining whether a subject is located at the center portion of the photographed image by using the subject distance information from the plurality of image capturing units, a highlight scene is selected when it is determined that the subject is located at the center portion. In addition, after determining whether the subject is approaching, the highlight scene is selected when it is determined that the subject is approaching. With such a configuration, it is possible to realize the highlight scene selection optimal for three-dimensional (3D) image display.

### BRIEF DESCRIPTION OF THE DRAWINGS

FIGS. 1A and 1B are diagrams illustrating a configuration example of an image capturing apparatus according to one embodiment of the invention;

FIG. 2 is a block diagram illustrating a hardware configuration example of an image capturing apparatus according to one embodiment of the invention;

FIGS. 3A to 3B are graphs illustrating an example in which a subject distance is measured;

FIG. 4 is a diagram illustrating one example of a highlight scene selection reference;

FIGS. 5A to 5D are diagrams illustrating one example of a highlight scene selection reference;

FIG. 6 is a diagram illustrating one example of a highlight scene selection reference;

FIG. 7 is a diagram illustrating an example of a highlight scene selection reference;

FIG. 8 is a flowchart illustrating a sequence of a highlight scene selection process performed by an image capturing apparatus according to one embodiment of the invention;

FIG. 9 is a diagram illustrating a configuration example of a directory of record data of an image capturing apparatus according to one embodiment of the invention;

FIG. 10 is a diagram illustrating an example in which highlight scene selection information is recorded;

FIG. 11 is a flowchart illustrating a sequence of a highlight scene selection process performed by an image capturing apparatus according to one embodiment of the invention;

FIG. 12 is a diagram illustrating time offset recorded in highlight scene selection information;

FIG. 13 is a diagram illustrating a configuration example of a directory of record data of an image capturing apparatus according to one embodiment of the invention;

FIG. 14 is a diagram illustrating an example in which highlight scene selection information is recorded;

FIG. 15 is a diagram illustrating time offset recorded in highlight scene selection information;

FIG. 16 is a diagram illustrating an example in which highlight scene selection information is recorded;

FIG. 17 is a diagram illustrating an example in which highlight scene selection information is recorded;

FIG. 18 is a diagram illustrating an example in which highlight scene selection information is recorded;

FIG. 19 is a diagram illustrating an example in which highlight scene selection information is recorded;

FIGS. 20A to 20C are diagrams illustrating an example in which a distance is measured in an image capturing apparatus; and

FIGS. 21A to 21C are diagrams illustrating an example of measurement of a subject distance and a highlight scene selection process in an image capturing apparatus.

### DESCRIPTION OF THE PREFERRED EMBODIMENTS

Hereinafter, an image capturing apparatus, an image processing method and a program according to an embodiment of the invention will be described in detail with reference to the accompanying drawings. The description will be given in order of the following items.

1. Configuration Example of Image Capturing Apparatus

2. Highlight Scene Extraction Process Based on Subject Distance

3. Configuration Example in which Highlight Scene Selection Information is recorded

3-a. Example in which Highlight Scene Selection Information is recorded in Clip Information File

3-b. Example in which Highlight Scene Selection Information is recorded in Play List File

4. Example of Other Pieces of Information used as Highlight Scene Selection Information

5. Example of the obtaining of Subject Distance Information and Highlight Scene Selection in case of Image Capturing Apparatus with Multiple Lens Configurations

### 1. Configuration Example of Image Capturing Apparatus

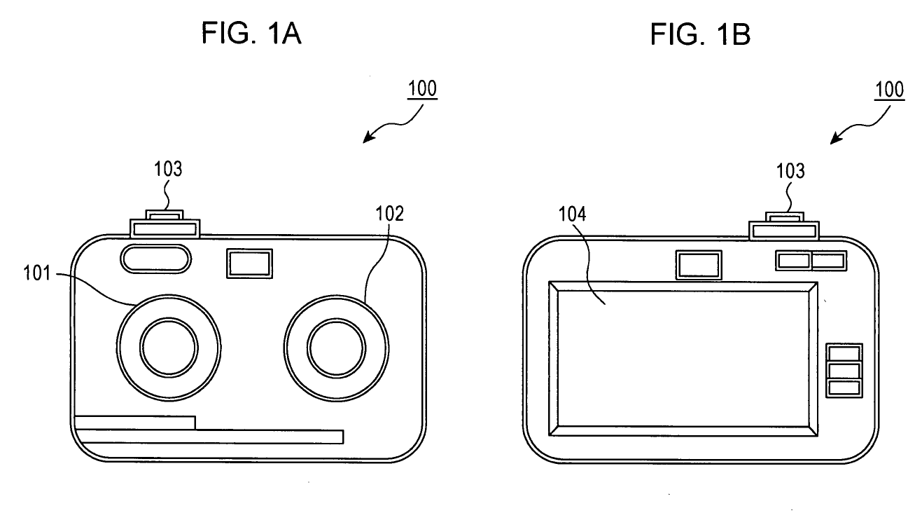

First, a configuration example of the image capturing apparatus according to one embodiment of the invention will be described with reference to FIG. 1.

FIGS. 1A and 1B are diagrams illustrating an external appearance of the image capturing apparatus according to one embodiment of the invention. The image capturing apparatus 100 according to the embodiment of the invention is provided with a plurality of lenses and an image capturing device and is configured to photograph images from multiple viewpoints. That is, the image capturing apparatus 100 is configured to photograph images from different viewpoints, which are used for a three-dimensional image display process.

FIGS. 1A and 1B illustrate the external appearance of the image capturing apparatus according to one embodiment of the invention, in which FIG. 1A is a front view of the image capturing apparatus and FIG. 1B is a rear view of the image capturing apparatus. As shown in the front view of FIG. 1A, the image capturing apparatus 100 includes two lenses for photographing images from viewpoints, that is, lenses 101 and 102. A shutter 103 is operated to photograph the images. Further, the image capturing apparatus 100 is able to photograph a moving image as well as a still image.

According to the image capturing apparatus 100, it is possible to set modes, that is, a still image photographing mode and a moving image photographing mode. In the still image photographing mode, the shutter 103 is pressed once to photograph a still image. In the moving image photographing mode, the shutter 103 is pressed once to start recording of a moving image and then is pressed once to complete the recording of the moving image. In relation to the still image and the moving image, images from different viewpoints via the lenses 101 and 102 are separately recorded in a memory of the image capturing apparatus 100.

Further, according to the image capturing apparatus 100, it is possible to switch a normal image photographing mode (2D mode) and a three-dimensional image photographing mode (3D mode). In the case of the normal image photographing mode, similarly to a general camera, photographing is performed using only one of the lenses 101 and 102.

As shown in the rear view of FIG. 1B, the image capturing apparatus 100 is provided on the rear surface thereof with a display unit 104 which displays a photographed image or is used as a user interface. The display unit 104 displays a through image as a present image photographed by the image capturing apparatus, and an image recorded on a memory and a recording medium. The displayed image can be switched into a still image, a moving image and a three-dimensional image according to user's instructions.

In addition, it is possible to perform highlight scene display as a display mode of a moving image recorded on a memory and a recording medium. That is, after highlight scenes are extracted from a plurality of image frames constituting the moving image according to a predetermined algorithm, only the extracted highlight scene images are sequentially displayed. A scheme for extracting the highlight scene will be described in detail later.

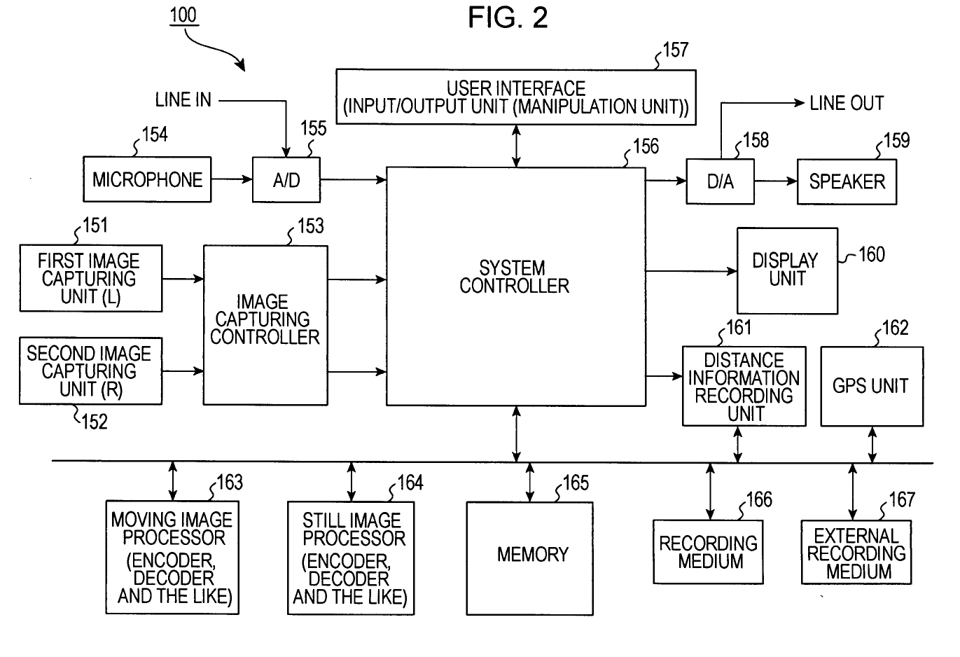

FIG. 2 is a block diagram illustrating the hardware configuration of the image capturing apparatus 100 according to one embodiment of the invention. A first image capturing unit (L) 151 corresponds to an image photographing unit provided with the lens 101 shown in FIG. 1 and a second image capturing unit (R) 152 corresponds to an image photographing unit provided with the lens 102 shown in FIG. 1. Each of the image capturing units 151 and 152 includes a lens and an image capturing device, which receives a subject image obtained through the lens, and outputs an electrical signal obtained by performing photoelectric conversion with respect to the subject image. When photographing is performed in the three-dimensional image photographing mode (3D mode), the first image capturing unit (L) 151 photographs an image (L image) for the left eye and the second image capturing unit (R) 152 photographs an image (R image) for the right eye.

Output of each of the image capturing units 151 and 152 is input to a system controller 156 via an image capturing controller 153. The system controller 156 sets a processing mode for input signals from each image capturing unit according to each setting mode of a photographing mode, i.e., a still image mode, a moving image mode, a two-dimensional mode and a three-dimensional mode, controls each element of the image capturing apparatus, and records record data generated as a result of processing on a recording medium 166 or an external recording medium 167. The system controller 156 functions as a recording controller in this way.

For example, in relation to moving image recording, a moving image processor 163 performs an encoding process to MPEG2TS data. In relation to still image recording, a still image processor 164 performs an encoding process to JPEG data. Further, when image photographing is performed in a three-dimensional mode, the moving image processor 163 or the still image processor 164 generates image data for displaying a three-dimensional image based on the images photographed by the image capturing units 151 and 152. For example, record data conforming to an AVCHD format is generated as moving image data.

In addition, when moving image data is recorded as a three-dimensional image (3D image), two images photographed by the first image capturing unit (L) 151 and the second image capturing unit (R) 152 are recorded as pair images. In relation to a display process, these pair images are alternately displayed. A user puts on shutter type glasses to observe a display image. That is, the user observes the image photographed by the first image capturing unit (L) through only the left eye and observes the image photographed by the second image capturing unit (R) 152 through only the right eye. Due to such a process, the three-dimensional image (3D image) can be observed. In addition, this is just one example of a 3D image record display scheme, and other schemes may also be employed.

Moreover, in relation to a process of recording the images photographed by the image capturing units 151 and 152 on media (the recording medium 166 and the external recording medium 167), attribute information of each image frame is also recorded. The attribute information includes subject distance information calculated from a focal distance. Further, the image capturing apparatus has an auto-focus function and sequentially measures distances from the image capturing units 151 and 152 to a subject when the image capturing units 151 and 152 separately perform an automatic focusing process.

The measured distance information is temporarily stored in a distance information recording unit 161. When a photographing process has been performed, subject distance information is recorded as attribute information corresponding to each photographed image. That is, the subject distance information is recorded on the media (the recording medium 166 and the external recording medium 167), on which the photographed images are recorded, together with the images. A recording configuration will be described in detail later.

In addition, the image capturing apparatus 100 includes the image capturing units 151 and 152, and the focal distance and the subject distance are separately measured as distances corresponding to the image capturing units. Hereinafter, a subject distance corresponding to the L image photographed by the left (L) lens will be referred to as [subject distance L] and a subject distance corresponding to the R image photographed by the right (R) lens will be referred to as [subject distance R]. These pieces of information is recorded as attribute information corresponding to an image.

Moreover, in the case of audio information, after audio is obtained by a microphone 154 and is converted into a digital signal by an A/D converter 155, the digital signal is recorded on the media (the recording medium 166 and the external recording medium 167) as sound information corresponding to an image.

A display unit 160 is used for displaying the through image and the image recorded on the media (the recording medium 166 and the external recording medium 167), displaying setting information, and the like. A speaker 159 outputs the recorded sound information and the like. For example, when performing a process of reproducing the image data recorded on the media (the recording medium 166 and the external recording medium 167), the recorded digital data is converted into an analog signal by a D/A converter 158.

A user interface 157 serves as a manipulation unit for a user. For example, the user interface 157 is used as an input unit for receiving instruction information of the start and end of a photographing operation, setting of a photographing mode such as a still image mode, a moving image mode, a 2D mode and a 3D mode, instruction information for designating a display mode of the display unit 160, and the like. In addition, the display process of the display unit 160 includes various display modes such as still image display, moving image display, 2D display, 3D display and highlight scene display.

Moreover, when performing highlight scene display of selecting only a specific highlight scene from the photographed image (e.g., the moving image) recorded on the recording medium and displaying the specific highlight scene, which will be described in detail later, a process is performed to select a specific image with reference to the attribute information recorded corresponding to the photographed image. The highlight scene selection and display process is performed under the control of the system controller 156. That is, the system controller 156 also functions as an image selection controller and a display controller.

A memory 165 is used as a temporary storage area of the image photographed by the image capturing apparatus, and a work area for processing a program executed in the image capturing apparatus, and parameters and data used for processes performed in the system controller 156 and other processing units.

A GPS unit 162 obtains location information of the image capturing apparatus by communicating with a GPS satellite. The obtained location information is recorded on the media (the recording medium 166 and the external recording medium 167) as attribute information corresponding to each photographed image.

### 2. Highlight Scene Extraction Process Based on Subject Distance

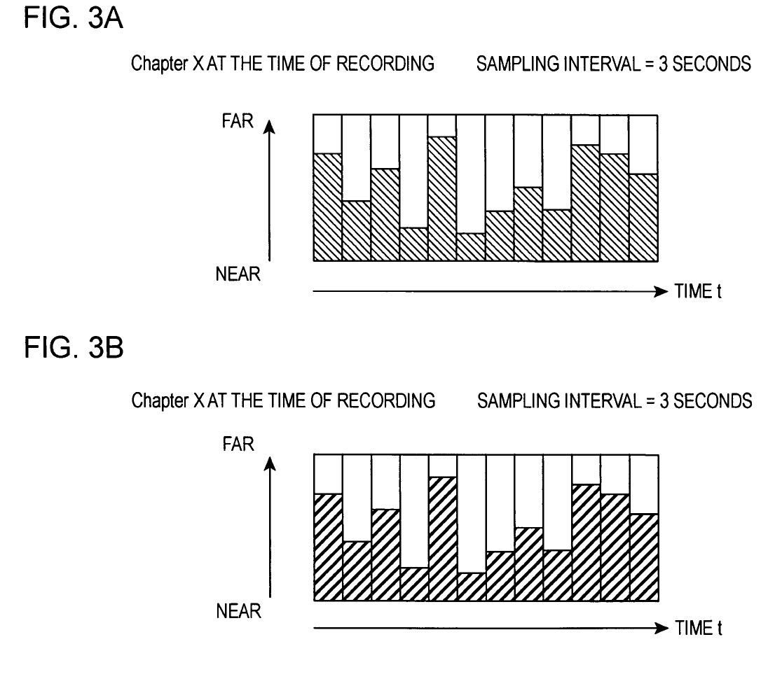

As described above, the image capturing apparatus 100 according to the embodiment of the invention records the subject distance information, which is measured as the focal distances of the image capturing units 151 and 152, as attribute information of each photographed image together with the image. In addition, the subject distance is measured at a predetermined sampling interval. An example of a process for measuring the subject distance will be described with reference to FIGS. 3A to 3B.

The image capturing apparatus measures the focal distance of the lens of the first image capturing unit (L) 151 as the subject distance L and the focal distance of the lens of the second image capturing unit (R) 152 as the subject distance R. FIGS. 3A to 3B are graphs illustrating a distance measurement result for each sampling time when a sampling interval T is set to three seconds.

FIG. 3A illustrates the subject distance L and FIG. 3B illustrates the subject distance R. In FIGS. 3A to 3B, a horizontal axis denotes time and a vertical axis denotes the subject distance. The image capturing apparatus according to the embodiment of the invention records the subject distance information (the subject distance L and the subject distance R) as the attribute information of the photographed images.

The image capturing apparatus performs an automatic extraction process of a highlight scene by using the subject distance information.

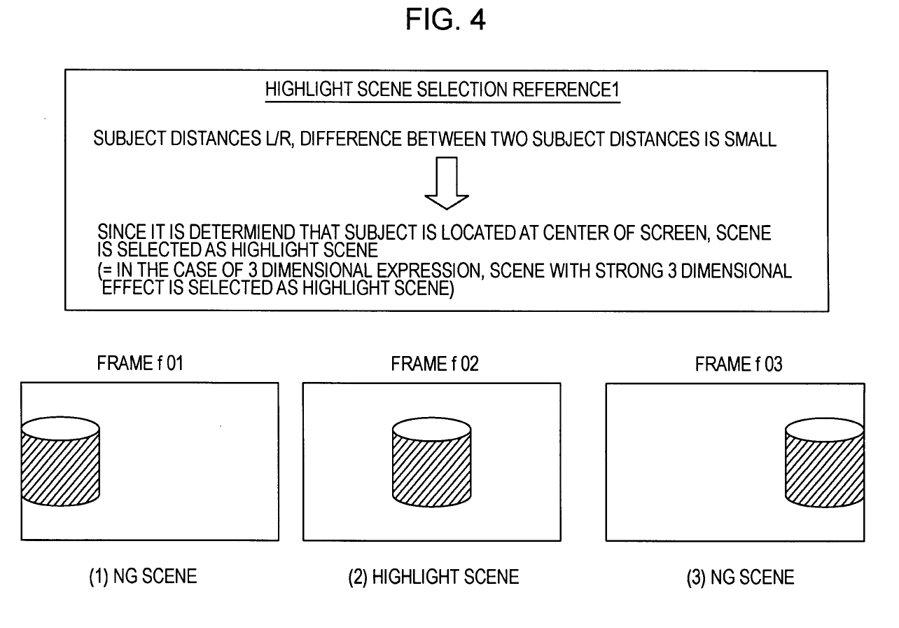

In order to select a highlight scene from a plurality of image frames constituting a moving image, a predetermined highlight scene selection reference is used. Hereinafter, the highlight scene selection reference used for the image capturing apparatus according to the embodiment of the invention will be described with reference to FIG. 4 and the drawings subsequent to FIG. 4.

When performing the highlight scene selection process, the image capturing apparatus according to the embodiment of the invention uses one or a plurality of selection references. Hereinafter, one example of the highlight scene selection reference will be described with reference to FIG. 4.

The highlight scene selection reference 1 shown in FIG. 4 represents that “the difference between the subject distance L and the subject distance R is small”. For an image satisfying this condition, since it is determined that a subject is located at the center of a screen, the image is extracted as a highlight scene.

FIG. 4 illustrates three types of image frames including (1) a NG scene, (2) a highlight scene and (3) a NG scene.

(1) In the NG scene, a subject is located at the left end of the screen. In such a case, since the subject distance L is smaller than the subject distance R, the image frame is not selected as an image of a highlight scene.

(2) In the highlight scene, a subject is located at the center of the screen. In such a case, since the subject distance L is approximately equal to the subject distance R, the image frame is selected as an image of a highlight scene.

(3) In the NG scene, a subject is located at the right end of the screen. In such a case, since the subject distance L is larger than the subject distance R, the image frame is not selected as an image of a highlight scene.

In addition, in the actual process, a predetermined threshold value is used and the difference between the subject distance L and the subject distance R is smaller than the threshold value (i.e., |subject distance L−subject distance R|<threshold value).

When the above equation is satisfied, it is possible to perform a process of selecting a corresponding image frame as a highlight scene.

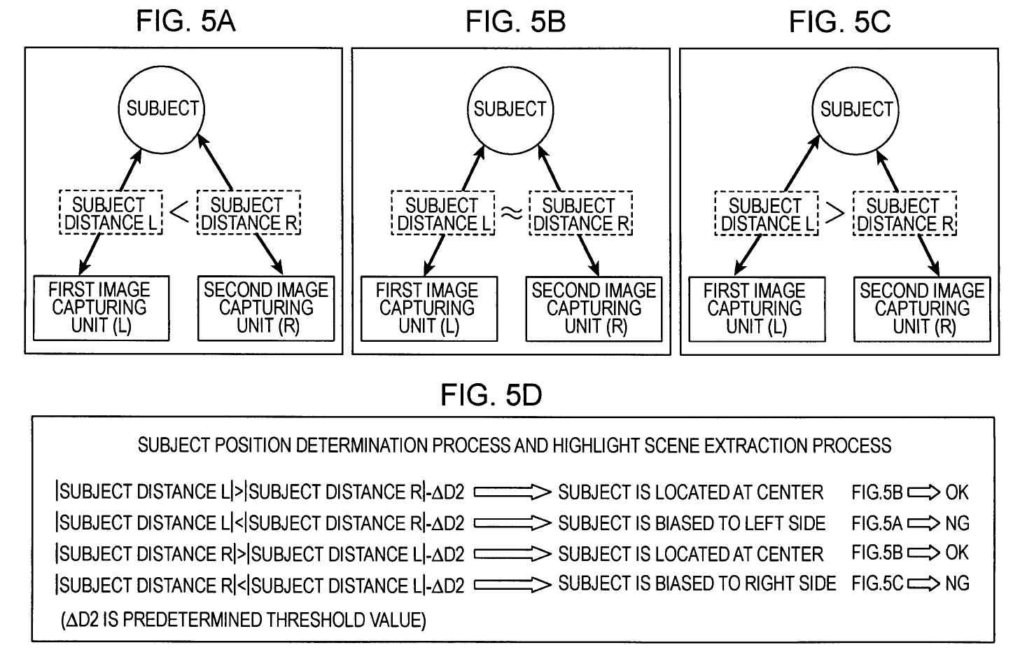

A detailed processing example will be described with reference to FIGS. 5A to 5D. Values of the subject distance L and the subject distance R can be set according to three patterns of FIGS. 5A to 5C. That is, FIG. 5A illustrates a first pattern of (subject distance L<subject distance R), FIG. 5B illustrates a second pattern of (subject distance L≈subject distance R), and FIG. 5C illustrates a three pattern of (subject distance L>subject distance R).

The image capturing apparatus according to the embodiment of the invention performs highlight scene selection by performing the subject position determination process as shown in FIG. 5D by using various patterns of subject distance information as described above. That is, as shown in FIG. 5D, the image capturing apparatus performs the following selection process.

|Subject distance L|>|Subject distance R|−ΔD2:

Since it is determined that a subject is located at the center of the screen (refer to FIG. 5B), the image frame is selected as the highlight scene.

|Subject distance L|<|Subject distance R|−ΔD2:

Since it is determined that a subject is biased to the left side of the screen (refer to FIG. 5A), that is, NG, the image frame is not selected as the highlight scene.

|Subject distance R|>|Subject distance L|−ΔD2:

Since it is determined that a subject is located at the center of the screen (refer to FIG. 5B), the image frame is selected as the highlight scene.

|Subject distance R|<|Subject distance L|−ΔD2:

Since it is determined that a subject is biased to the right side of the screen (refer to FIG. 5C), that is, NG, the image frame is not selected as the highlight scene.

The highlight scene selection is performed through such a determination process.

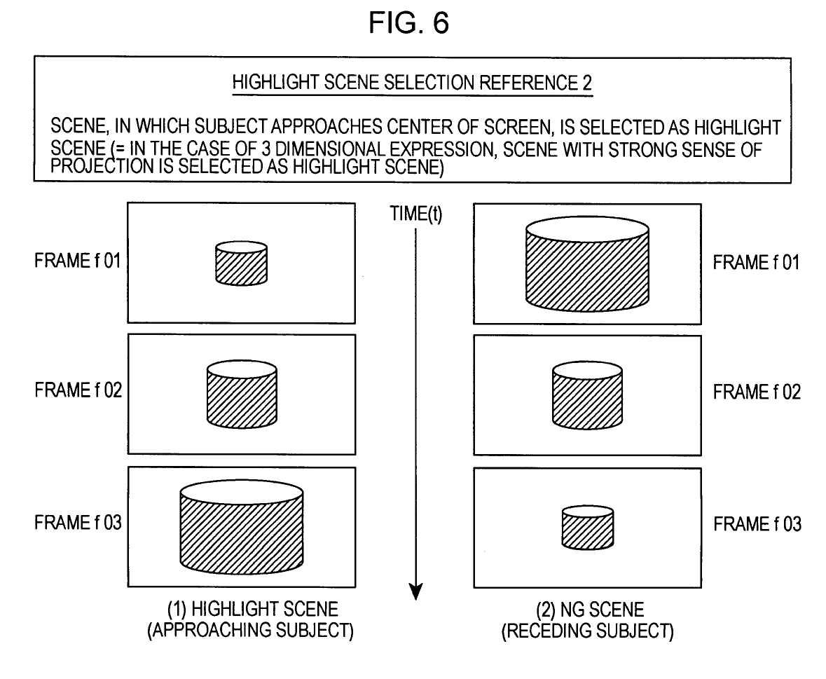

Hereinafter, one example of another highlight scene selection reference used for the image capturing apparatus according to the embodiment of the invention will be described with reference to FIG. 6.

The highlight scene selection reference 2 shown in FIG. 6 represents that “a subject is approaching the center of a screen”. In an image satisfying this condition, since it is determined that a subject is gradually approaching the image capturing apparatus and a photographer pays attention to the subject, the image is extracted as a highlight scene.

FIG. 6 illustrates an example of moving image frames including (1) a highlight scene (approaching subject) and (2) a NG scene (receding subject).

FIG. 6 illustrates frames f01 to f03 from the top according to the passage of time.

The image capturing apparatus performs a process of obtaining distance information from the attribute information recorded corresponding to consecutive frames constituting a moving image, selecting a frame group in which a subject distance is reduced according to the progress of the frame, and extracting a frame for several seconds before and after when the distance becomes the shortest in a scene as the highlight scene. In such a case, the highlight scene becomes a moving image for short time (several seconds).

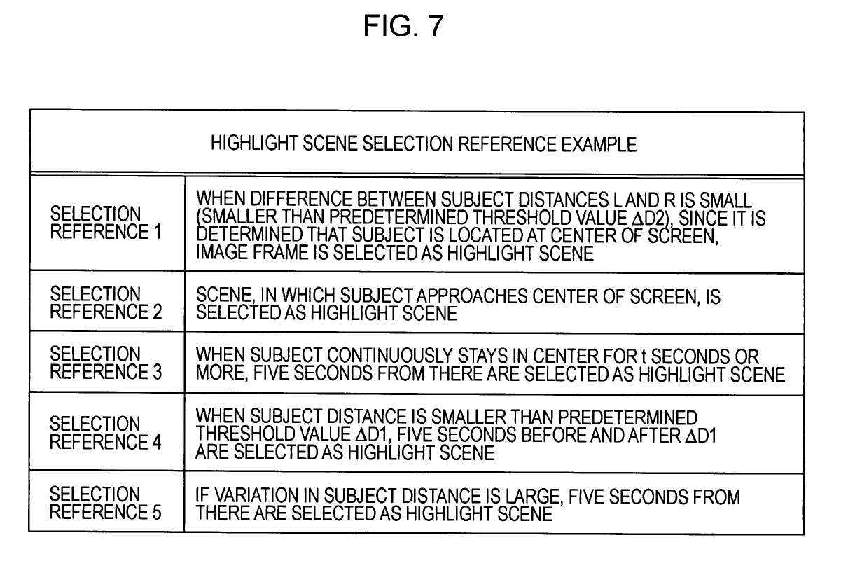

FIG. 7 is a diagram collectively illustrating an example of highlight scene selection references used for the embodiment of the invention. For example, the highlight scene selection references used for the embodiment of the invention are as follows.

Selection reference 1: when the difference between the subject distances L and R is small (is smaller than the predetermined threshold value ΔD2), since it is determined that the subject is located at the center of the screen, the image frame is selected as the highlight scene.

Selection reference 2: a scene, in which a subject is approaching the center of the screen, is selected as the highlight scene.

Selection reference 3: when a subject continuously stays in the center for t seconds or more, a frame for five seconds from there is selected as the highlight scene.

Selection reference 4: when the subject distance is smaller than a predetermined threshold value ΔD1, a frame for five seconds about that is selected as the highlight scene.

Selection reference 5: if variation in the subject distance is large, a frame for five seconds from there is selected as the highlight scene.

For example, the image capturing apparatus according to the embodiment of the invention performs the highlight scene extraction by using the five selection references. In addition, it may be possible to employ a configuration of selectively using one or more of the five selection references. Moreover, the selection reference 1 corresponds to the selection reference described with reference to FIGS. 4 and 5A to 5D and the selection reference 2 corresponds to the selection reference described with reference to FIG. 6.

Furthermore, any one of the selection references 1 to 5 shown in FIG. 7 is based on the distance information of the attribute information recorded corresponding to the photographed image. The image capturing apparatus according to the embodiment of the invention performs the highlight scene selection by using the distance information as described above.

For example, the highlight scene selection process is performed in response to an execution instruction for the highlight scene display process from a user. A user performs the highlight scene display process through the user interface. In addition, when performing the highlight scene selection process, a user can arbitrarily select any one of the selection references 1 to 5.

For example, the highlight scene selection process is performed in response to an instruction for a highlight scene reproduction process from a user, and only a highlight scene selected based on the selection reference is displayed on the display unit.

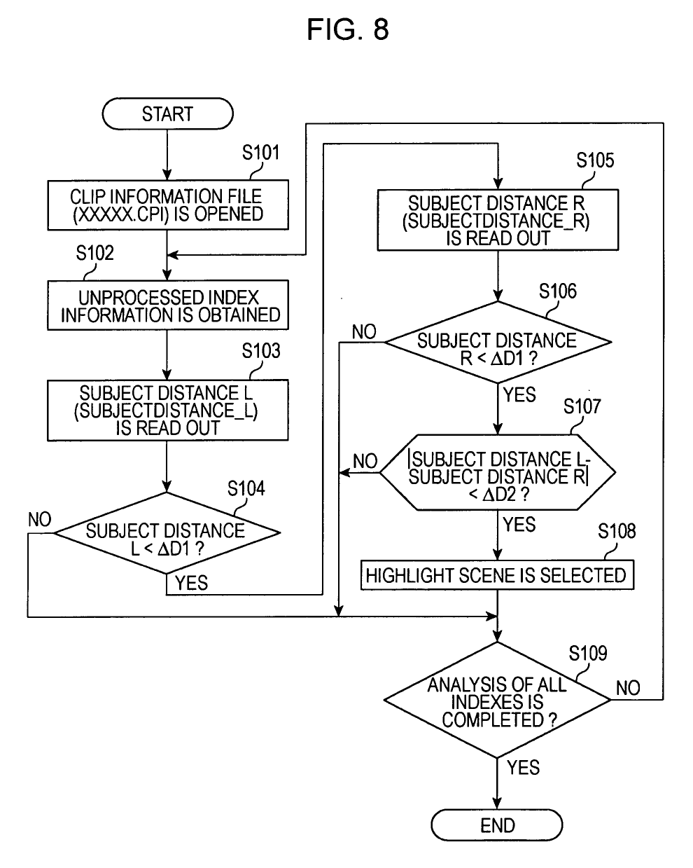

Hereinafter, a sequence example of the highlight scene selection process performed in the image capturing apparatus according to the embodiment of the invention will be described with reference to the flowchart of FIG. 8. The flow shown in FIG. 8 represents the sequence when performing the highlight scene selection based on the selection references 1 and 4. This process is performed under the control of the system controller 156.

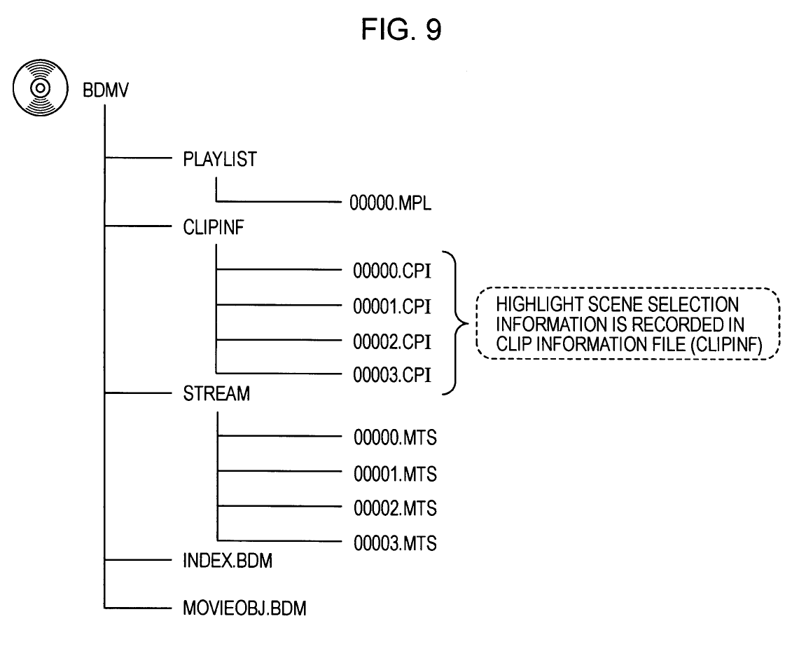

In addition, FIG. 8 illustrates an example in which distance information as highlight scene selection information is recorded in a clip information file. Before description about the flow of FIG. 8 is given, files set when moving image data is recorded will be described. FIG. 9 is a diagram illustrating a BDMV directory as an example of a configuration in which moving image data is recorded on media. This is a directory configuration conforming to a AVCHD format.

As shown in FIG. 9, a play list file (PLAYLIST), a clip information file (CLIPINF), a stream file (STREAM), an index file (INDEX.BDM), a movie object file (MOVIEOBJ.BDM) are recorded in the BDMV directory.

The play list file (PLAYLIST) is provided corresponding to a title shown to a user and serves as a reproduction list including at least one play item (PlayItem). Each play item has a reproduction start point (IN point) and a reproduction end point (OUT point) for a clip to designate a reproduction section thereof. A plurality of play items in the play list are arranged on a time axis, so that a reproduction sequence of respective reproduction sections can be designated.

The clip information file (CLIPINF) exists together with the stream file (STREAM), which stores the moving image data, as a pair, and includes information regarding a stream necessary for reproducing an actual stream. The stream file (STREAM) stores the moving image data to be reproduced. The moving image data is stored as MPEG data.

The index file (INDEX.BDM) is a management information file and is used for managing designation information of a title shown to a user, and a movie object (reproduction program corresponding to the title), and the like.

The movie object file (MOVIEOBJ.BDM) is the reproduction program corresponding to the title to manage a play list used for reproduction.

The process of the flowchart shown in FIG. 8 illustrates an example in which the highlight scene selection information (i.e., distance information) is recorded in the clip information file (CLIPINF), and the highlight scene selection is performed using the clip information file (CLIPINF).

Hereinafter, the process of each step of the flowchart shown in FIG. 8 will be described.

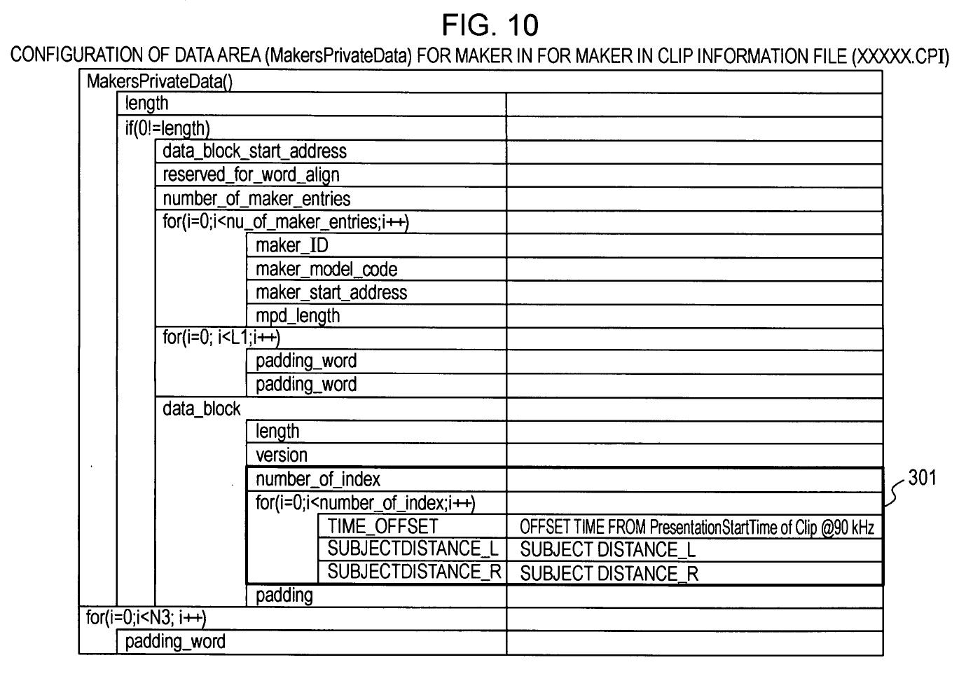

In Step S101, the clip information file is obtained and opened. In addition, a data area (MakerPrivateData) for a maker as shown in FIG. 10 is set in the clip information file, and highlight scene selection information 301 is recorded in the data area.

In Step S102, index information set in the highlight scene selection information 301 of the data area (MakerPrivateData) for the maker as shown in FIG. 10 is obtained. In the highlight scene selection information 301, index information for each image is set and the distance information (i.e., the subject distance L and the subject distance R) is recorded corresponding to each index.

As shown in FIG. 10, information on time offset, the subject distance L and the subject distance R is recorded in the highlight scene selection information 301.

The time offset indicates offset time from a presentation time start time of a clip, which is prescribed in the clip information file. The time offset is recorded in a [TIME_OFFSET] field. This information will be described later.

The subject distance L is subject distance information corresponding to the focal distance of the first image capturing unit (L) 151 and is recorded in a [SUBJECTDISTANCE_L] field.

The subject distance R is subject distance information corresponding to the focal distance of the second image capturing unit (R) 152 and is recorded in a [SUBJECTDISTANCE_R] field.

In addition, as described above, when moving image data is recorded as a three-dimensional image (3D image), two images photographed by the first image capturing unit (L) 151 and the second image capturing unit (R) 152 are recorded as one pair of pair images. Information corresponding to the one pair of pair images is recorded in the highlight scene selection information 301 of the clip information file (CLIPINF) shown in FIG. 10.

In Step S102 of the flow, after one index included in the highlight scene selection information 301 is obtained, Step S103 is performed. In Step S103, after registration information of one index of the highlight scene selection information 301 shown in FIG. 10 is extracted, the recorded subject distance L (SUBJECTDISTANCE_L) is read.

In Step S104, the subject distance (SUBJECTDISTANCE_L) obtained in Step S103 is compared with the predetermined threshold value ΔD1.

Subject distance L<ΔD1 Equation 1

Equation 1 relates to an application process of a highlight scene selection reference corresponding to the selection reference 4 described with reference to FIG. 7.

When Equation 1 is established, Step S105 is performed. However, when Equation 1 is not established, Step S109 is performed to determine the existence of an unprocessed index. When the unprocessed index exists in Step S109, Step S102 is performed to process the subsequent unprocessed index.

If Equation 1 is established and Step S105 is performed, after the registration information of one index of the highlight scene selection information 301 shown in FIG. 10 is extracted, the recorded subject distance (SUBJECTDISTANCE_R) is read.

In Step S106, the subject distance (SUBJECTDISTANCE_R) obtained from the clip information file in Step S105 is compared with the predetermined threshold value ΔD1.

Subject distance R<ΔD1 Equation 2

Equation 2 also relates to the application process of a highlight scene selection reference corresponding to the selection reference 4 described with reference to FIG. 7.

When Equation 2 is established, Step S107 is performed. However, when Equation 2 is not established, Step S109 is performed to determine the existence of an unprocessed index. When the unprocessed index exists, Step S102 is performed to process the subsequent unprocessed index.

If Equation 2 is established and Step S107 is performed, the difference between the subject distance L and the subject distance R is compared with the predetermined threshold value ΔD2, so that it is determined whether a subject is located at the center of a screen (image frame). That is, it is determined whether Equation 3 below is established.

|Subject distance L−Subject distance R|<ΔD2 Equation 3

The determination process of Step S107 is an application process based on a highlight scene selection reference corresponding to the selection reference 1 described with reference to FIG. 7. That is, the determination process is an application process of the highlight scene selection reference described with reference to FIGS. 4 and 5A to 5D.

When Equation 3 is established, it can be determined that the difference between the subject distance L and the subject distance R is small and the subject is located nearly at the center of the screen. However, when Equation 3 is not established, it is determined that the difference between the subject distance L and the subject distance R is large and the subject is located at the end of the screen. In such a case, Step S109 is performed to determine the existence of an unprocessed index. When the unprocessed index exists, Step S102 is performed to process the subsequent unprocessed index.

When Equation 3 is established, it can be determined that the difference between the subject distance L and the subject distance R is small and the subject is located nearly at the center of the screen. In such a case, Step S108 is performed to select the image as a highlight scene. Further, for example, a pair of an image for the left eye and an image for the right eye are set as an image used for three-dimensional display and a three-dimensional display image (3D image) is presented using both images for the right and left eyes, so that these images are selected as a highlight scene image.

Further, for highlight scene display of a moving image, one still image is not sufficient and a moving image for short time (e.g., five seconds) is selected as a highlight scene image for display. In such a setting, a process is performed to display an image for before and after five seconds, which includes the highlight scene image selected in Step S108, as the highlight scene image. Alternately, after the highlight scene image selected in Step S108 is employed as a start image, an image for five seconds may be set to be displayed as the highlight scene.

If the highlight scene image is selected in Step S108, Step S109 is performed to determine the existence of an unprocessed index. When the unprocessed index exists in Step S109, Step S102 is performed to process the subsequent unprocessed index.

In Step S109, if it is determined that no unprocessed index exists, the highlight scene selection process is completed. If the highlight scene selection process is completed in this way, the image, which corresponds to an index number selected as the highlight scene, is selected, so that the highlight scene display process is performed. In addition, it may be possible to employ a configuration in which highlight scene image display is performed using a moving image for short time, which includes an image before and after the selected image as described above.

Moreover, it may be possible to employ a configuration in which the index number selected as the highlight scene is recorded in a management information file and the like and preserved. If such a setting is made, for example, the highlight scene selection process according to the flow shown in FIG. 8 is performed only once, so that it is then possible to select and display a highlight scene image according to an index number obtained with reference to management information.

The flow described with reference to FIG. 8 corresponds to a sequence when performing the highlight scene selection based on the selection references 1 and 4 shown in FIG. 7.

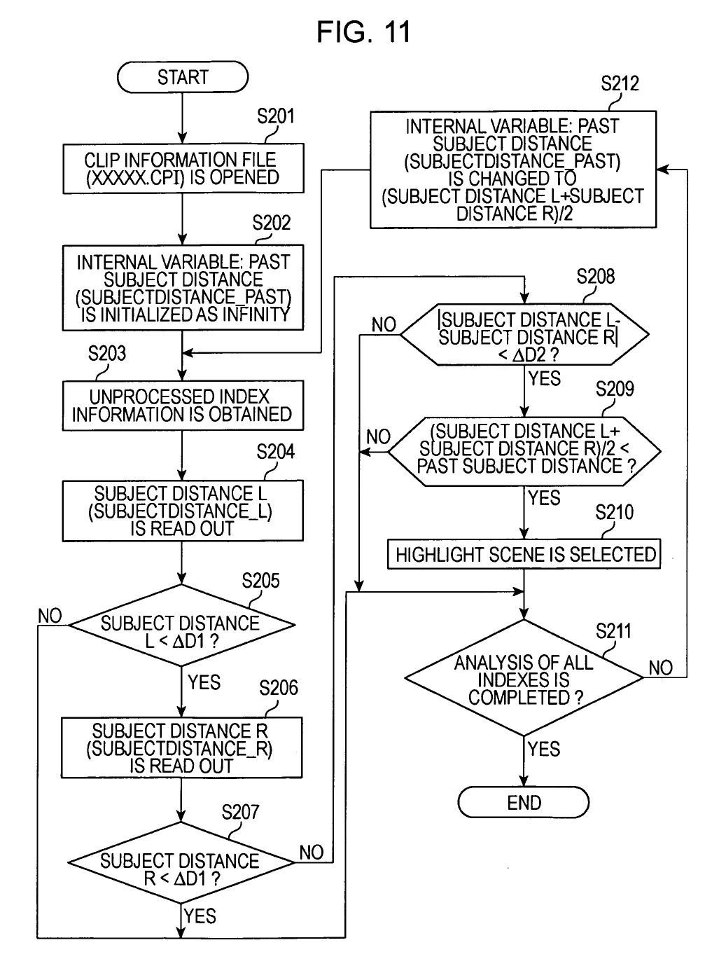

Next, a sequence when performing highlight scene selection based on the selection references 1, 2 and 4 shown in FIG. 7 will be described with reference to the flow shown in FIG. 11. That is, the flow of FIG. 11 includes the process (selection reference 2) of selecting the highlight scene when a subject is approaching as described with reference to FIG. 6, in addition to the flow shown in FIG. 8.

As described above, the flow shown in FIG. 11 represents the sequence when performing the highlight scene selection based on the selection references 1, 2 and 4. This process is performed under the control of the system controller 156.

In addition, FIG. 11 illustrates an example in which distance information as highlight scene selection information is recorded in a clip information file. The process of the flowchart shown in FIG. 11 illustrates an example in which the highlight scene selection information (i.e., distance information) is recorded in the clip information file (CLIPINF), and the highlight scene selection is performed using the clip information file (CLIPINF). Hereinafter, the process of each step of the flowchart shown in FIG. 11 will be described.

In Step S201, the clip information file is obtained and opened. The above-described data area (MakerPrivateData) for the maker as shown in FIG. 10 is set in the clip information file, and the highlight scene selection information 301 is recorded in the data area.

In Step S202, an initialization process is performed to set the past subject distance (SUBJECTDISTANCE_PAST) as an internal variable to an infinity.

In Step S203, the index information set in the highlight scene selection information 301 of the data area (MakerPrivateData) for the maker as shown in FIG. 10 is obtained. In the highlight scene selection information 301, the index information for each image is set and the distance information (i.e., the subject distance L and the subject distance R) is recorded corresponding to each index.

In Step S203 of the flow, one index included in the highlight scene selection information 301 is obtained and Step S204 is performed. In Step S204, after registration information of one index of the highlight scene selection information 301 shown in FIG. 10 is extracted, the recorded subject distance L (SUBJECTDISTANCE_L) is read.

In Step S205, the subject distance (SUBJECTDISTANCE_L) obtained in Step S204 is compared with the predetermined threshold value ΔD1.

Subject distance L<ΔD1 Equation 1

Equation 1 relates to the application process of the highlight scene selection reference corresponding to the selection reference 4 described with reference to FIG. 7.

When Equation 1 is established, Step S206 is performed. However, when Equation 1 is not established, Step S211 is performed to determine the existence of an unprocessed index. When the unprocessed index exists, Step S212 is performed to update an internal variable. That is, the past subject distance (SUBJECTDISTANCE_PAST) is updated into (subject distance L+subject distance R)/2. In addition, when any one of the subject distance L and the subject distance R is not obtained, the past subject distance (SUBJECTDISTANCE_PAST) is set to the infinity. Moreover, Step S203 is performed to process the subsequent unprocessed index.

If Equation 1 is established and Step S206 is performed, after the registration information of one index of the highlight scene selection information 301 shown in FIG. 10 is extracted, the recorded subject distance R (SUBJECTDISTANCE_R) is read.

In Step S207, the subject distance R (SUBJECTDISTANCE_R) obtained from the clip information file in Step S206 is compared with the predetermined threshold value ΔD1.

Subject distance R<ΔD1 Equation 2

Equation 2 also relates to the application process of the highlight scene selection reference corresponding to the selection reference 4 described with reference to FIG. 7.

When Equation 2 is established, Step S208 is performed. However, when Equation 2 is not established, Step S211 is performed to determine the existence of an unprocessed index. When the unprocessed index exists, Step S212 is performed to update the internal variable. Then, Step S203 is performed to process the subsequent unprocessed index.

If Equation 2 is established and Step S208 is performed, the difference between the subject distance L and the subject distance R is compared with the predetermined threshold value ΔD2, so that it is determined whether a subject is located at the center of the screen (image frame). That is, it is determined whether Equation 3 below is established.

|Subject distance L−Subject distance R|<ΔD2 Equation 3

The determination process of Step S208 is the application process based on a highlight scene selection reference corresponding to the selection reference 1 described with reference to FIG. 7. That is, the determination process is the application process of the highlight scene selection reference described with reference to FIGS. 4 and 5A to 5D.

When Equation 3 is established, it can be determined that the difference between the subject distance L and the subject distance R is small and the subject is located nearly at the center of the screen. In such a case, Step S209 is performed. However, when Equation 3 is not established, it is determined that the difference between the subject distance L and the subject distance R is large and the subject is located at the end of the screen. In such a case, Step S211 is performed to determine the existence of an unprocessed index. When the unprocessed index exists, Step S212 is performed to update the internal variable. Then, Step S203 is performed to process the subsequent unprocessed index.

When Equation 3 is established, it can be determined that the difference between the subject distance L and the subject distance R is small and the subject is located nearly at the center of the screen. In such a case, Step S209 is performed to determine whether Equation 4 below is established.

(Subject distance L+Subject distance R)/2<past subject distance Equation 4

Equation 4 represents that the subject is approaching according to the progress (passage of time) of the image frame. That is, it represents that the scene of (1) of FIG. 6, in which the subject approaches, is obtained.

In such a case, Step S210 is performed to select the image as a highlight scene. However, when Equation 3 is not established, Step S211 is performed to determine the existence of an unprocessed index. When the unprocessed index exists, Step S212 is performed to update the internal variable. Then, Step S203 is performed to process the subsequent unprocessed index.

As described above, for example, a pair of an image for the left eye and an image for the right eye are set as an image used for three-dimensional display and a three-dimensional display image (3D image) is presented using the both images for the right and left eyes, so that these images are selected as a highlight scene image.

Further, for highlight scene display of a moving image, one still image is not sufficient and a moving image for short time (e.g., five seconds) is selected as a highlight scene image for display. In such a setting, a process is performed to display an image for before and after five seconds, which includes the highlight scene image selected in Step S210, as the highlight scene image. Alternately, after the highlight scene image selected in Step S210 is employed as a start image, an image for five seconds may be set to be displayed as the highlight scene.

If the highlight scene image is selected in Step S210, Step S211 is performed to determine the existence of an unprocessed index. When the unprocessed index exists in Step S211, Step S212 is performed to update the internal variable. Then, Step S203 is performed to process the subsequent unprocessed index.

In Step S211, if it is determined that no unprocessed index exists, the highlight scene selection process is completed. If the highlight scene selection process is completed in this way, the image, which corresponds to an index number selected as the highlight scene, is selected, so that the highlight scene display process is performed. In addition, it may be possible to employ a configuration in which highlight scene image display is performed using a moving image for short time, which includes an image before and after the selected image as described above.

Moreover, it may be possible to employ a configuration in which the index number selected as the highlight scene is recorded in a management information file and the like and preserved. If such a setting is made, for example, the highlight scene selection process according to the flow shown in FIG. 8 is performed only once, so that it is then possible to select and display a highlight scene image according to an index number obtained with reference to management information.

### 3. Configuration Example in which Highlight Scene Selection Information is Recorded

As described before, the information used for the highlight scene selection process is for example recorded in the data area (MakerPrivateData) for the maker of the clip information file as shown in FIG. 10. However, the highlight scene selection information may be recorded in other files as well as the clip information file as shown in FIG. 10. Hereinafter, an example (a) in which the highlight scene selection information is recorded in the clip information file, and an example (b) in which the highlight scene selection information is recorded in the play list file will be described.

### 3-a. Example in which Highlight Scene Selection Information is Recorded in Clip Information File

The highlight scene selection information 301 will be described in detail with reference to FIG. 10. As shown in FIG. 10, the information on the time offset, the subject distance L and the subject distance R is recorded in the highlight scene selection information 301. These pieces of information is separately recorded for each index number corresponding to an image.

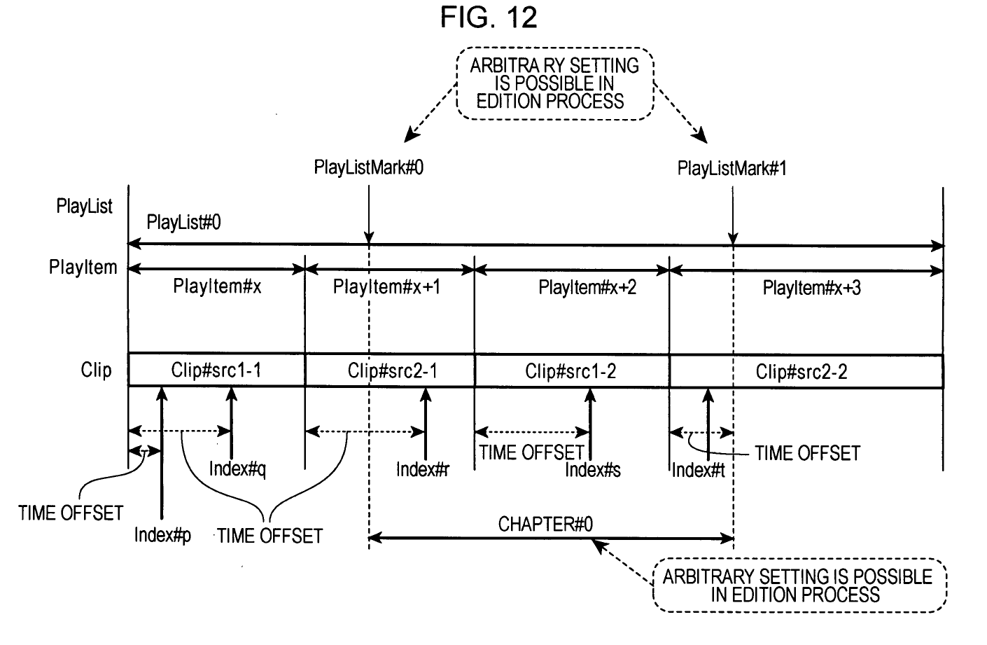

The time offset is offset time from the presentation time start time of the clip. The time offset will be described with reference to FIG. 12. FIG. 12 illustrates the correspondence among a play list, a play item included in the play list, and clips defined by the clip information file.

The clip information file represents a file in which information on the clips is registered, and one clip is allowed to correspond to one stream file (STREAM) in a one-to-one manner.

Each of the clips shown in FIG. 12, that is, (clip#src1-1), (clip#src2-1), (clip#src1-2) and (clip#src2-2), is allowed to correspond to the individual stream file (STREAM) in a one-to-one manner.

First, the play list (PlayList), which has been described with reference to FIG. 9, is provided corresponding to the title shown to a user, and is the reproduction list including at least one play item (PlayItem). Each play item (PlayItem) has a reproduction start point (IN point) and a reproduction end point (OUT point) for a clip to designate a reproduction section thereof. For example, a chapter as the reproduction section can be arbitrarily set by a play list mark (PlayListMark) shown in FIG. 12. The play list mark (PlayListMark) and the chapter can be set at arbitrary positions by an editing process performed by a user.

Each of indexes p to t (Index#p to #t) shown in FIG. 12 is an index number corresponding to the image selected as the highlight scene.

Each of the indexes corresponds to the index number of the highlight scene selection information 301 recorded in the data area (MakerPrivateData) for the maker of the clip information file as shown in FIG. 10.

The time offset (TIME_OFFSET) serving as the information recorded in the highlight scene selection information 301 is the offset time from the presentation time start time of the clip, and corresponds to an offset from the head of each clip as shown in FIG. 12.

When performing the highlight scene reproduction process, it is possible to specify an index position in the clip with reference to the time offset (TIME_OFFSET) serving as the information recorded in the highlight scene selection information 301 shown in FIG. 10, and to extract image data corresponding to an index position of the specified clip from the stream file (STREAM).

### 3-b. Example in which Highlight Scene Selection Information is Recorded in Play List File

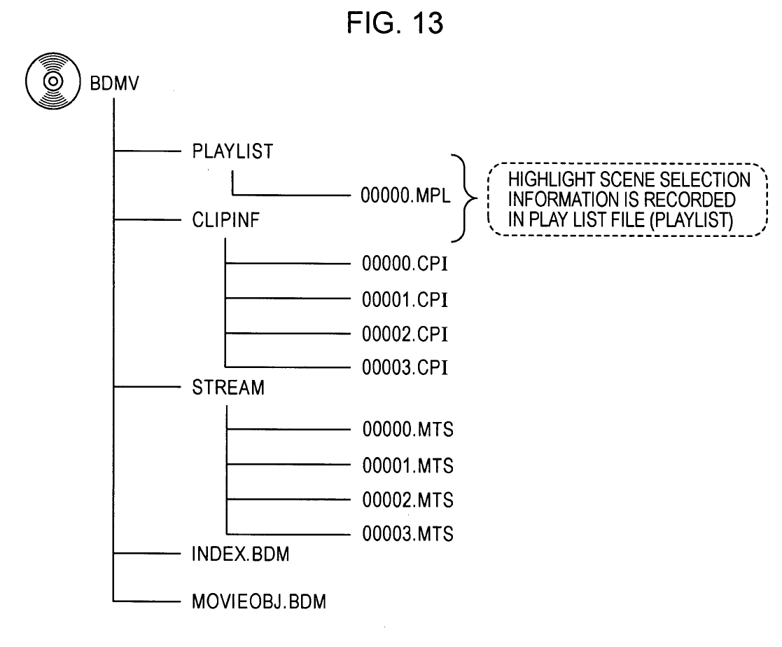

The highlight scene selection information such as the subject distance information (subject distance L and subject distance R) may also be stored in other files as well as the clip information file. The example in which the highlight scene selection information is recorded in the play list file will be described with reference to FIG. 13 and the drawings subsequent to FIG. 13.

FIG. 13 is a diagram illustrating a BDMV directory equal to that described with reference to FIG. 9. The play list file (PLAYLIST), the clip information file (CLIPINF), the stream file (STREAM), the index file (INDEX.BDM), the movie object file (MOVIEOBJ.BDM) are recorded in the BDMV directory.

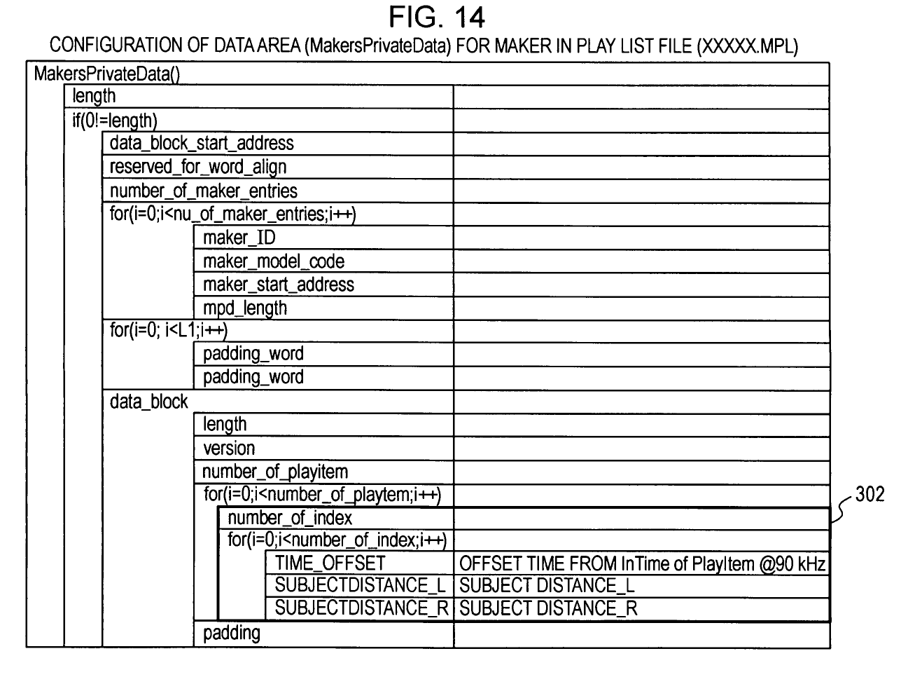

According to the example, the highlight scene selection information (i.e., distance information) is recorded in the play list file (PLAYLIST). Similarly to the clip information file described with reference to FIG. 10, as shown in FIG. 14, the data area (MakerPrivateData) for the maker is also recorded in the play list file (PLAYLIST), and highlight scene selection information 302 is recorded in the data area (MakerPrivateData) for the maker as shown in FIG. 14.

As shown in FIG. 14, information on the time offset, the subject distance L and the subject distance R is recorded in the highlight scene selection information 302. These pieces of information are separately recorded for each index number corresponding to an image.

The subject distance L is subject distance information corresponding to the focal distance of the first image capturing unit (L) 151.

The subject distance R is subject distance information corresponding to the focal distance of the second image capturing unit (R) 152.

However, differently from the previous example in which the highlight scene selection information is recorded in the clip information file, offset time from in-time (Intime) of play item (PlayItem) is recorded in the [TIME_OFFSET] field according to the example.

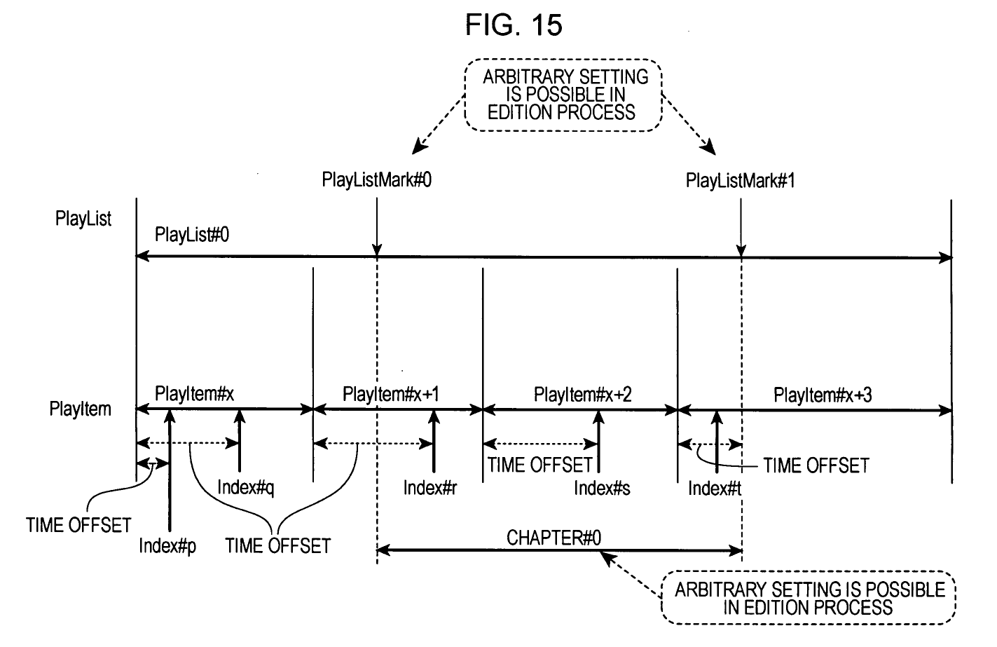

The offset time will be described with reference to FIG. 15. FIG. 15 illustrates a correspondence between a play list and a play item included in the play list. The play list (PlayList) is provided corresponding to the title shown to a user and serves as the reproduction list including at least one play item (PlayItem).

Each of indexes p to t (Index#p to #t) shown in FIG. 15 is an index number corresponding to the image selected as the highlight scene.

Each of the indexes corresponds to the index number of the highlight scene selection information 302 recorded in the data area (MakerPrivateData) for the maker of the play list file as shown in FIG. 14.

The time offset (TIME_OFFSET) serving as the information recorded in the highlight scene selection information 302 is the offset time from the Intime of the play item (PlayItem), and corresponds to offset from the head of each play item as shown in FIG. 15.

When performing the highlight scene reproduction process, it is possible to specify a corresponding position of an index in the play item with reference to the time offset (TIME_OFFSET) serving as the information recorded in the highlight scene selection information 302 shown in FIG. 14, and to extract image data specified by the specified index position of the play item from the stream file (STREAM).

### 4. Example of Other Pieces of Information Used as Highlight Scene Selection Information

In the previous embodiment, the configuration in which the subject distance information (the subject distance L and the subject distance R) as the highlight scene selection information is recorded has been described. However, in the following description, a processing example in which information different from the subject distance information is recorded as the highlight scene selection information will be described.

Hereinafter, an example in which data recorded as the highlight scene selection information is set as follows will be described.

(a) Subject distance information (the subject distance L and the subject distance R), (b) face recognition information and (c) GPS measurement position information are recorded as the highlight scene selection information.

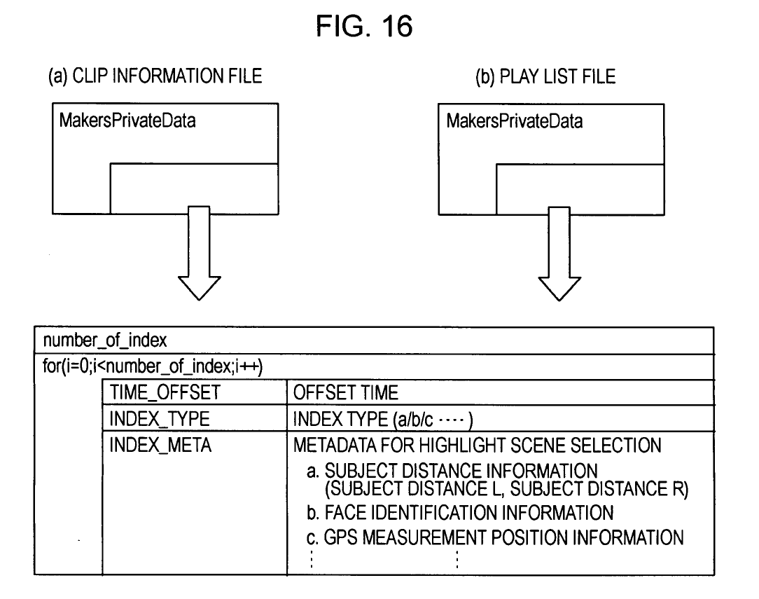

FIG. 16 is a diagram illustrating a configuration example of the highlight scene selection information recorded in the data area (MakerPrivateData) for the maker set in the above-described clip information file or play list file.

In the example, it is possible to record the three types of information in the data area (MakerPrivateData) for the maker.

Any one of the information (a) to (c) or multiple pieces of information is recorded as the highlight scene selection information according to an index number.

In the example, as shown in FIG. 16, the highlight scene selection information includes time offset (TIME_OFFSET), an index type (INDEX_TYPE) and index meta-information (INDEX_META).

When a file in which the highlight scene selection information is recorded is the clip information file, the time offset (TIME_OFFSET) is the offset time from the presentation time start time of the clip, similarly to the time offset described with reference to FIGS. 10 and 12.

Further, when a file in which the highlight scene selection information is recorded is the play list file, the time offset (TIME_OFFSET) is the offset time from the InTime of the play item (PlayItem), similarly to the time offset described with reference to FIGS. 14 and 15.

The index type (INDEX_TYPE) indicates a field in which information representing the type of metadata recorded in the subsequent data area [index meta-information (INDEX_META)] is recorded.

The correspondence between the index type and the index meta is as follows.

When the index type is the subject distance, the subject distance information (the subject distance L and the subject distance R) is recorded in the subsequent index meta-information field.

When the index type is the face recognition information, the face recognition information is recorded in the subsequent index meta-information field.

When the index type is the GPS information, location information of the image capturing apparatus measured by the GPS unit is recorded in the subsequent index meta-information field.

Alternatively, all the three types of information may also be recorded in one index image, or only one piece of information or two types of information may be recorded. When all the three types of information is recorded in one index image, the information is recorded in the following sequence: the subject distance information (the subject distance L and the subject distance R) as the index meta when the index type is the subject distance; the face recognition information as the index meta when the index type is the face recognition information; and the GPS measurement position information as the index meta when the index type is the GPS information.

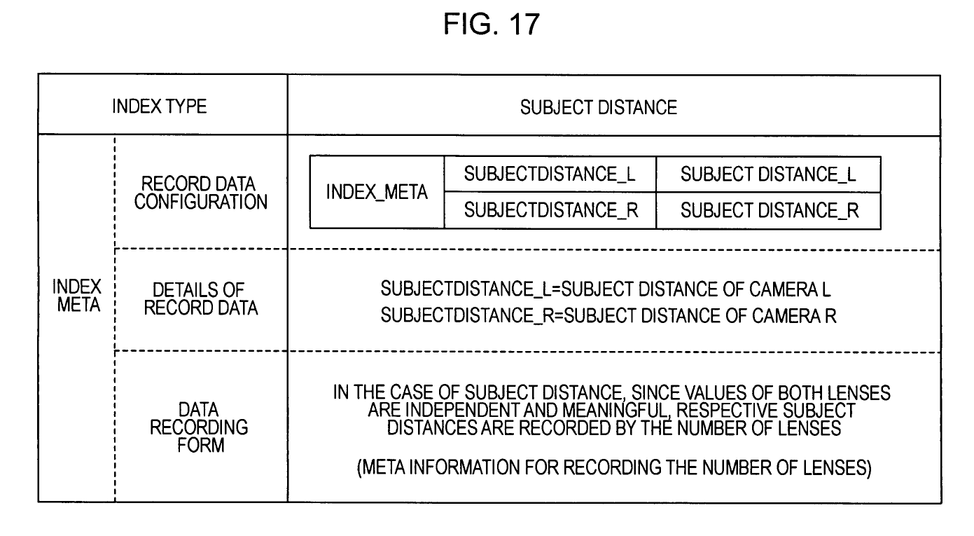

Hereinafter, details and recording forms of each piece of information will be described with reference to FIGS. 17 to 19.

FIG. 17 is a diagram illustrating details and recording forms of the index meta-information when the index type is the subject distance. When the index type is the subject distance, information equal to that described in the above-described embodiment is recorded as the index meta-information.

That is, information on the subject distance L and the subject distance R is recorded.

The subject distance L is subject distance information corresponding to the focal distance of the first image capturing unit (L) 151 and is recorded in the [SUBJECTDISTANCE_L] field.

The subject distance R is subject distance information corresponding to the focal distance of the second image capturing unit (R) 152 and is recorded in the [SUBJECTDISTANCE_R] field.

In the case of the subject distance, since distance values measured by both lenses (i.e., the image capturing units 151 and 152) are independent and meaningful, the respective subject distances are recorded by the number of the lenses.

In addition, in the embodiment, the two-lens configuration has been described. However, in the case of multiple lens configurations having three or more image capturing units each provided with lenses, all pieces of distance information measured by the image capturing units is recorded. That is, distance information is recorded by the number of lenses.

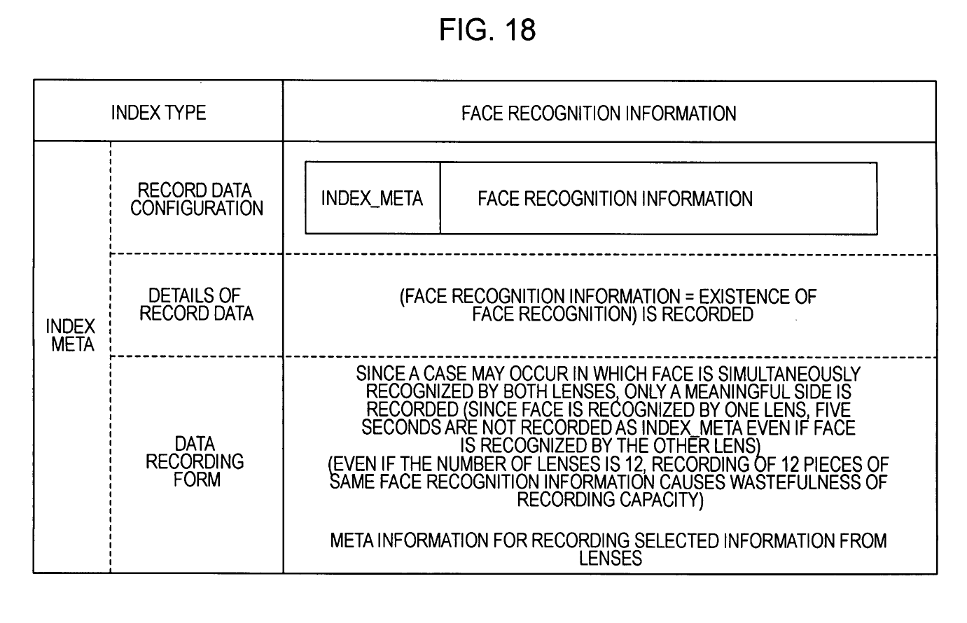

FIG. 18 is a diagram illustrating details and recording forms of the index meta-information when the index type is the face recognition. When the index type is the face recognition, the existence of face recognition, that is, information on the existence of a face, which represents that a face image area recognized as the face is included in a photographed image, is recorded as the index meta-information. In addition, a process of determining whether the face area is included in the photographed image is performed by the system controller 156 shown in FIG. 2. The system controller 156 uses previously stored characteristic information on a face image to determine the existence of eyes based on an area coinciding with or similar to the characteristic information in the photographed image, thereby determining the existence of the face area.

In addition, a case of recognizing the face from both images simultaneously photographed by the image capturing units 151 and 152 is assumed. In such a case, separately storing the information of each image may cause the wastefulness of a recording capacity. In this regard, for example, when a face image is detected from an image photographed by any one of the image capturing units, detection information on the face image is recorded. Moreover, when a face area is detected from an image photographed by one of the image capturing units, predetermined time (e.g., five seconds) is not recorded as metadata even if the face is detected from an image photographed by the other one of the image capturing units.

In such a setting, a process is performed to record only meaningful face recognition information as metadata.

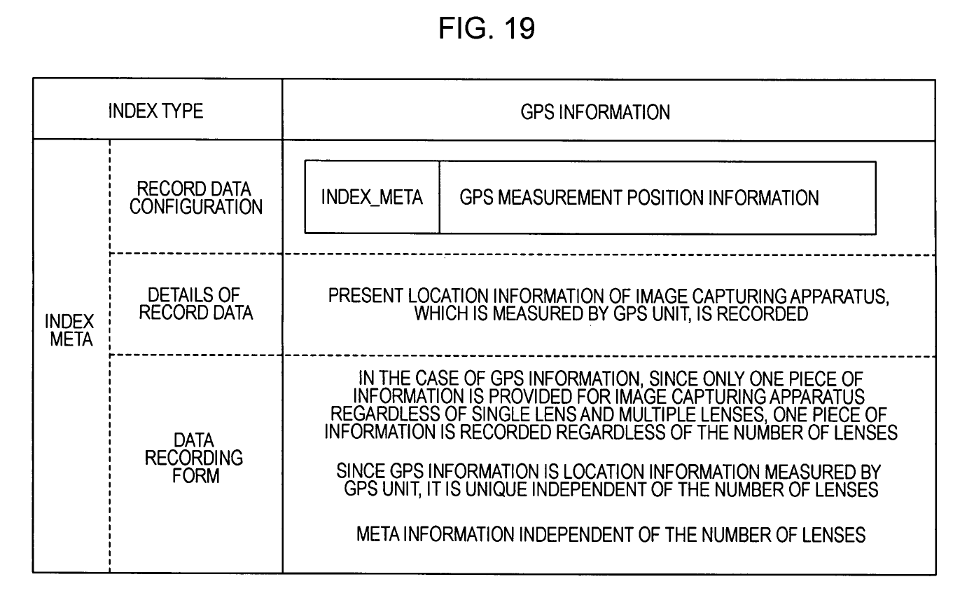

FIG. 19 is a diagram illustrating details and recording forms of the index meta-information when the index type is the GPS information. When the index type is the GPS information, present location information of the image capturing apparatus measured by the GPS unit 162 is recorded as the index meta-information.

In addition, in the case of the GPS information, since only one piece of measurement information is obtained for each measurement timing with respect to the image capturing apparatus regardless of a single lens and multiple lenses, only one piece of measurement information is recorded for each one measurement time regardless of the number of lenses.

In this way, (a) the subject distance information (the subject distance L and the subject distance R), (b) the face recognition information and (c) the GPS measurement position information are recorded as the highlight scene selection information.

In the case of selecting a highlight scene, according to the designation of a user, for example, a process is performed to select an image, for which a face is recognized, as the highlight scene, or a process is performed to select only an image photographed at a specific position as the highlight scene and to display the same.

The system controller 156 performs the highlight scene selection process according to these pieces of information.

In addition, it may be possible to employ a configuration of selecting the highlight scene by using an appropriate combination of the information of (a) to (c).

For example, it is possible to perform a process of selecting only an image as the highlight scene, which satisfies any one or multiple of the highlight scene selection references 1 to 5 using the subject distance information described with reference to FIG. 7, and for which a face is recognized.

Alternatively, it is possible to perform a process of selecting only an image as the highlight scene, which satisfies any one or multiple of the highlight scene selection references 1 to 5 using the subject distance information described with reference to FIG. 7, and which is photographed at a specific position.

### 5. Example of the Obtaining of Subject Distance Information and Highlight Scene Selection in Case of Image Capturing Apparatus with Multiple Lens Configurations

In the previous embodiment, the two-lens configuration has been described. That is, the above description has been given while focusing on the configuration example in which the image capturing unit 151 is provided with the lens 101 and the image capturing unit 152 is provided with the lens 102 as shown in FIGS. 1 and 2.

However, the invention is not limited to the two-lens configuration. For example, the invention can also be applied to multiple lens configurations having three or more image capturing units each provided with lenses. That is, it may be possible to employ a configuration of recording and using all pieces of distance information measured by the three or more image capturing units. In such a case, the distance information corresponding to the number of the lenses is recorded and the highlight scene selection is performed using the distance information.

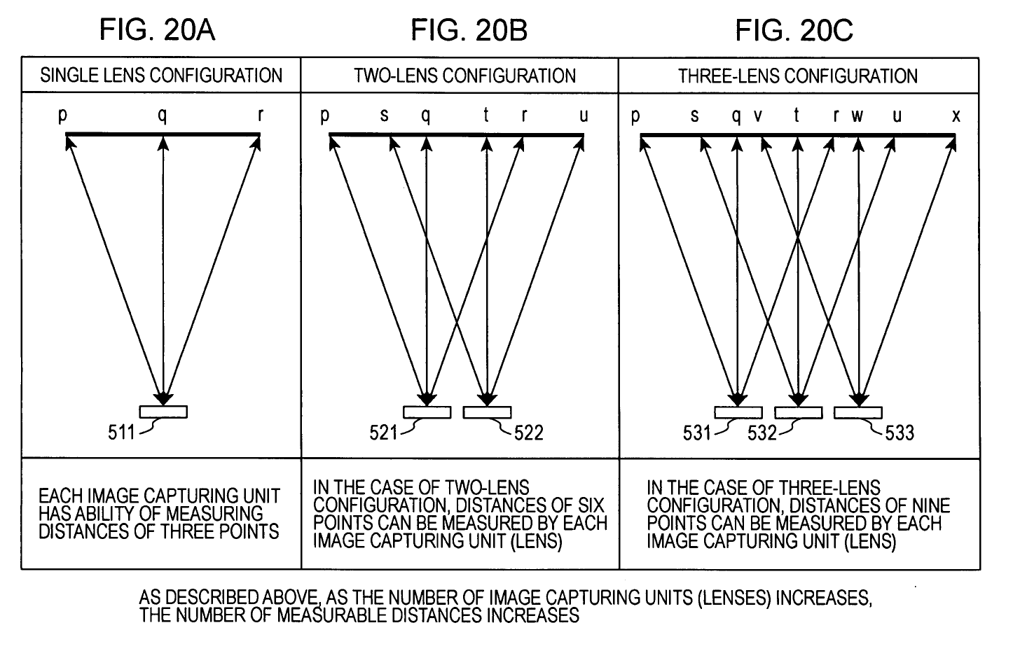

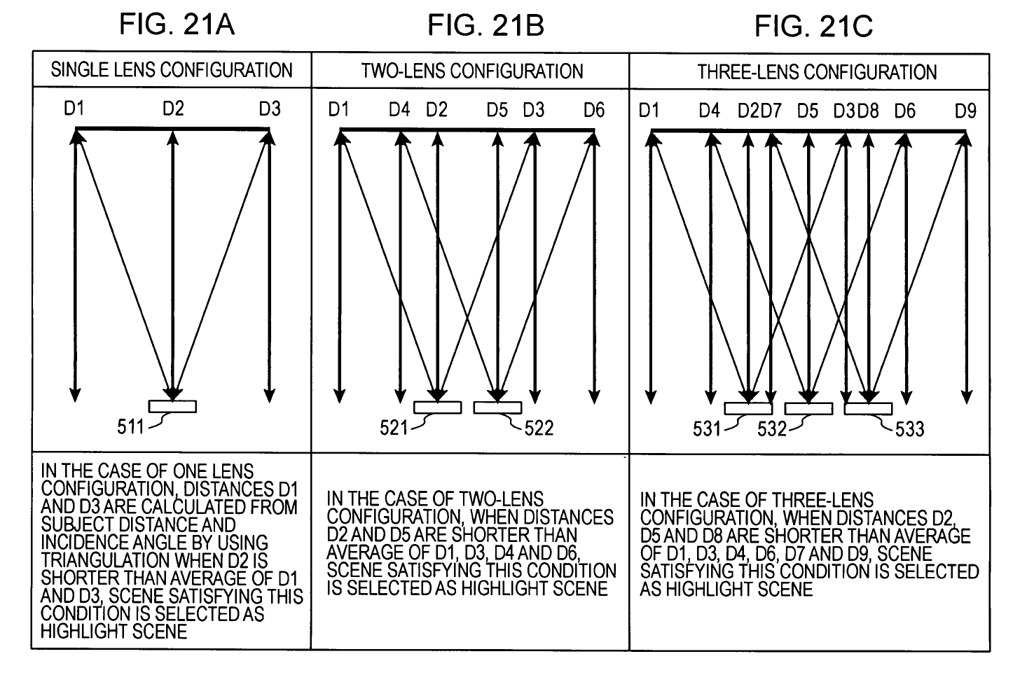

A detailed example will be described with reference to FIGS. 20A to 20C and 21A to 21C. FIGS. 20A to 20C are diagrams illustrating an example of distance measurement points of the image capturing apparatus having single-lens configuration, two-lens configuration and three-lens configuration.

According to the single-lens configuration, a configuration of an image capturing unit 511, which is an existing camera and has one lens, is provided. For example, it is possible to measure the distances to three points (p, q and r) shown in FIG. 20A by using an auto-focus function. In such a case, the measured distances are indicated by arrows shown in FIG. 20A and represent distances from the center of the lens of the image capturing unit 511. That is, for the points p and r, the distances in an oblique direction are measured.

The two-lens configuration, for example, corresponds to the image capturing apparatus shown in FIG. 1 described according to the previous embodiment. That is, a configuration in which two image capturing units 521 and 522 each provided with a lens is provided. In such a case, the image capturing units can separately measure the distances to three points. As a result, the distances to six points (p, q, r, s, t and u) shown in FIG. 20B can be measured by the two image capturing units 521 and 522.

According to the three-lens configuration, for example, an image capturing unit provided with one lens is added to the image capturing apparatus shown in FIG. 1. As shown in FIG. 20C, three image capturing units 531 to 533 each provided with a lens are provided. For example, it is possible to measure the distances to nine points (p, q, r, s, t, u, v, w and x) shown in FIG. 20C by using an auto-focus function.

In this way, as the number of the distance measurement points increases with the increase in the number of lenses, for example, determination regarding whether a subject exists in the center or the end of a screen can be performed with more precision.

An example of a highlight scene selection process performed by image capturing apparatuses having such single-lens configuration, two-lens configuration and three-lens configuration based on subject distance measurement information will be described with reference to FIGS. 21A to 21C. FIGS. 21A to 21C are diagrams illustrating an example of subject distance information Dn in each distance measurement point, which is obtained by the image capturing apparatuses having the single-lens configuration, the two-lens configuration and the three-lens configuration. In addition, the distance Dn in FIGS. 21A to 21C represents distances of sections indicated by thick arrows shown in FIGS. 21A to 21C and distances in the vertical direction from the surfaces of the image capturing apparatuses 511, 521, 522, 531, 532 and 533.

In the case of the single-lens configuration, the subject distances D1 to D3 shown in FIG. 21A are calculated as subject distance information corresponding to a photographed image and then recorded as attribute information. The distance D2 corresponds to the distance to the point q shown in FIG. 20A. The distances D1 and D3 are calculated using triangulation based on the distances (the distances in an oblique direction from lenses) to the points p and r described in FIG. 20A and incidence angles with respect to the lenses.

For example, the following reference expressed by Equation below can be used as a highlight scene selection reference when the three subject distances D1 to D3 are obtained.

D2<(D1+D3)/2

When the above Equation is satisfied, it represents that the subject distance at the center portion of the screen is shorter than the subject distance at the peripheral portion of the screen. That is, it represents that the target subject is located at the short distance of the center thereof. Such a scene is selected as a highlight scene.

In the case of the two-lens configuration, the subject distances D1 to D6 shown in FIG. 21B are calculated as subject distance information corresponding to a photographed image and then recorded as attribute information. The distances D2 and D5 correspond to the distances to the points q and t shown in FIG. 20B, respectively. The distances D1, D3, D4 and D6 are calculated using the triangulation similarly to the case of the single-lens configuration.

For example, the following reference expressed by Equation below can be used as a highlight scene selection reference when the six subject distances D1 to D6 are obtained.

D2<(D1+D3+D4+D6)/4, and

D5<(D1+D3+D4+D6)/4

When the above Equation is established, a highlight scene is selected.

Satisfying the above Equation represents that the subject distance at the center portion (in the vicinity of D2 and D5) of the screen is shorter than the subject distance at the peripheral portion of the screen. That is, it represents that the target subject is located at the short distance of the center thereof. Such a scene is selected as a highlight scene.

In the case of the three-lens configuration, the subject distances D1 to D9 shown in FIG. 21C are calculated as subject distance information corresponding to a photographed image and then recorded as attribute information. The distances D2, D5 and D8 correspond to the distances to the points q, t and w shown in FIG. 20C, respectively. The distances D1, D3, D4, D6, D7 and D9 are calculated using the triangulation similarly to the case of the single-lens configuration.

For example, the following reference expressed by Equation below can be used as a highlight scene selection reference when the nine subject distances D1 to D9 are obtained.

D2<(D1+D3+D4+D6+D7+D9)/6,

D5<(D1+D3+D4+D6+D7+D9)/6, and

D8<(D1+D3+D4+D6+D7+D9)/6

When the above Equation is established, a highlight scene is selected.

Satisfying the above Equation represents that the subject distance at the center portion (in the vicinity of D2, D5 and D8) of the screen is shorter than the subject distance at the peripheral portion of the screen. That is, it represents that the target subject is located at the short distance of the center thereof. Such a scene is selected as a highlight scene.

In this way, in the case of the multiple lens configurations, the number of measureable subject distances increases, and the highlight scene selection reference is set according to the increase in the number of the measureable subject distances and is applied to the highlight scene selection process.

While there have been described what are at present considered to be certain embodiments of the invention, it should be understood by those skilled in the art that various modifications, combinations, sub-combinations and alterations may occur depending on design requirements and other factors insofar as they are within the scope of the appended claims or the equivalents thereof. The scope of the invention has to be determined based on the appended claims.

Further, a series of processes described in the specification can be performed by a hardware, a software or the composite configuration of them. When the processes are performed by the software, a program recording a process sequence can be installed in a memory in a computer having a dedicated hardware therein so as to be performed. Alternatively, the program can be installed in a general purpose computer capable of performing various types of processes, so that the program can be performed. For example, the program can be recorded in advance on a recording medium. In addition to the case in which the program is installed in the computer from the recording medium, the program can be downloaded through a LAN (Local Area Network) or a network called the Internet, and installed on a recording medium such as a hard disk embedded in a computer.

In addition, various types of processes written in the specification may be performed in time-series as is written, and may also be separately performed or performed in a parallel manner according to processing capability of an apparatus performing the processes or requirements of the situation. Further, the system in the specification corresponds to a logical aggregation configuration of a plurality of apparatuses, and it is not necessarily that the apparatuses having each configuration exist in the same casing.

The present application contains subject matter related to that disclosed in Japanese Priority Patent Application JP 2009-158570 filed in the Japan Patent Office on Jul. 3, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image capturing apparatus comprising:
a plurality of image capturing units that photograph images from a plurality of viewpoints;
a recording controller that performs a process of recording a plurality of subject distances, which are measured by each of the plurality of image capturing units, on a recording unit as attribute information of the photographed images; and
an image selection controller that performs a highlight scene extraction process by using subject distance information included in the attribute information,
wherein the image selection controller performs a process of determining whether a subject is located at a center area of an image frame by using the plurality of subject distances, which correspond to each of the plurality of image capturing units and are included in the attribute information, and selecting an image, for which the subject is determined to be located at the center area, as a highlight scene.

2. The image capturing apparatus according to claim 1, wherein the image selection controller performs a process of determining an existence of an image in which the subject approaches the image capturing apparatus according to passage of time with reference to the subject distances of the time-series photographed images, and selecting the image, for which the subject is determined to approach the image capturing apparatus, as the highlight scene.

3. The image capturing apparatus according to claim 1 or 2, wherein the image selection controller performs a process of selecting a moving image, which is configured by consecutive photographed images including the image, for which the subject is determined to be located at the center area of the image frame, as the highlight scene.

4. The image capturing apparatus according to claim 1, wherein the recording controller records the subject distance information in any one of a clip information file serving as a management file corresponding to a stream file set as a record file of a photographed moving image, and a play list file storing a reproduction list.

5. The image capturing apparatus according to claim 4, wherein, when the subject distance information is recorded in the clip information file, the recording controller records offset time from presentation time start time of a clip, which is prescribed in the clip information file, as time offset information representing a position of an image for which the subject distance is measured, and when the subject distance information is recorded in the play list file, the recording controller records offset time from in-time (InTime) set corresponding to a play item, which is included in a play list, as the time offset information representing the position of the image for which the subject distance is measured.

6. The image capturing apparatus according to claim 1, wherein the recording controller performs a process of allowing face recognition information representing whether a face area is included in the images photographed by the image capturing units to be included in the attribute information, and recording the attribute information on a recording unit, and the image selection controller performs a process of selecting an image, for which face recognition has been performed, as the highlight scene with reference to the face recognition information included in the attribute information.

7. The image capturing apparatus according to claim 1, wherein the recording controller performs a process of allowing GPS information representing a position, at which the images are photographed by the image capturing units, to be included in the attribute information, and recording the attribute information on a recording unit, and the image selection controller performs a process of selecting an image photographed at a specific position as the highlight scene with reference to the GPS information included in the attribute information.

8. The image capturing apparatus according to claim 1, wherein the plurality of image capturing units are configured by at least three image capturing units, the recording controller performs a process of recording subject distances, which are measured by each of the at least three image capturing units, on a recording unit as attribute information of photographed images, and the image selection controller performs a process of determining whether a subject is located at a center area of an image frame by using the plurality of subject distances included in the attribution information and corresponding to each of the at least three image capturing units, and selecting an image, for which the subject is determined to be located at the center area, as the highlight scene.

9. An image processing method performed by an image capturing apparatus, the image processing method comprising the steps of:
photographing, by a plurality of image capturing units, images from a plurality of viewpoints;
recording, by a recording controller, subject distances, which are measured by each of the plurality of image capturing units, on a recording unit as attribute information of the photographed images; and
performing, by an image selection controller, a highlight scene extraction process by using subject distance information included in the attribute information,
wherein in the step of performing the highlight scene extraction process, it is determined whether a subject is located at a center area of an image frame by using the plurality of subject distances included in the attribute information and corresponding to each of the plurality of image capturing units, and an image, for which the subject is determined to be located at the center area, is selected as a highlight scene.

10. A program causing an image capturing apparatus to execute functions of:
allowing a plurality of image capturing units to photograph images from a plurality of viewpoints;
allowing a recording controller to record subject distances, which are measured by each of the plurality of image capturing units, on a recording unit as attribute information of the photographed images; and
allowing an image selection controller to perform a highlight scene extraction process by using subject distance information included in the attribute information,
wherein in the highlight scene extraction process, it is determined whether a subject is located at a center area of an image frame by using the plurality of subject distances included in the attribute information and corresponding to each of the plurality of image capturing units, and an image, for which the subject is determined to be located at the center area, is selected as a highlight scene.
